(19) United States
(12) Patent Application Publication
(10) Pub. No.: US 2018/0130569 A1
(43) Pub. Date: May 10, 2018

(54) GRAPHENE-POLYMER NANOCOMPOSITES INCORPORATING CHEMICALLY DOPED GRAPHENE-POLYMER HETEROSTRUCTURE FOR FLEXIBLE AND TRANSPARENT CONDUCTING FILMS

(71) Applicants: THE REGENTS OF THE UNIVERSITY OF CALIFORNIA, Oakland, CA (US); KING ABDULAZIZ CITY FOR SCIENCE AND TECHNOLOGY, Riyadh (SA)

(72) Inventors: Kang L. Wang, Santa Monica, CA (US); Chandan Biswas, Los Angeles, CA (US)

(73) Assignees: THE REGENTS OF THE UNIVERSITY OF CALIFORNIA, Oakland, CA (US); KING ABDULAZIZ CITY FOR SCIENCE AND TECHNOLOGY, Riyadh (SA)

(21) Appl. No.: 15/807,222

(22) Filed: Nov. 8, 2017

Related U.S. Application Data
(60) Provisional application No. 62/419,411, filed on Nov. 8, 2016.

(51) Int. Cl. H01B 1/04; H01B 1/12; H01B 13/00

(52) U.S. Cl. CPC H01B 1/04; H01B 13/0036; H01B 1/124

(57) ABSTRACT

Flexible, conductive, graphene-polymer nanocomposites incorporating doped graphene and conductive polymer materials in a layered structure and tunable methods of fabrication are provided. The layered graphene-polymer nanocomposites exhibit resistance quenching by suppressing defect induced carrier scattering in graphene while keeping the optical transmittance greater than 90%, which is essential for many optoelectronic applications. Nanocomposites also demonstrate high mobility and carrier density compared to known TCF materials as well as very low sheet resistance with flexibility of more than ±90 degrees of bending angle. The methods employ layer-by-layer mixed chemical doping strategies that incorporate different doping species to enhance electrical and optical properties individually. The synthesis of the graphene-polymer nanocomposite may be conducted by chemical processes to provide mass production capabilities.

### CROSS-REFERENCE TO RELATED APPLICATIONS

This application claims priority to, and the benefit of, U.S. provisional patent application Ser. No. 62/419,411 filed on Nov. 8, 2016, incorporated herein by reference in its entirety.

### STATEMENT REGARDING FEDERALLY SPONSORED RESEARCH OR DEVELOPMENT

Not Applicable

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### INCORPORATION-BY-REFERENCE OF COMPUTER PROGRAM APPENDIX

Not Applicable

### BACKGROUND

### 1. Technical Field

The technology of this disclosure pertains generally to fabrication methods and applications of transparent conductive films and electrodes, and more particularly to devices and methods for fabricating flexible, transparent, conductive graphene-polymer nanocomposite thin films for use in optical-electrical devices such as light emitting devices and solar cells.

### 2. Background Discussion

High quality flexible transparent conducting films (FTCF) are essential building blocks for optoelectronic technologies. Uses of transparent conducting films include flexible touch screens, rollable displays, flexible light emitting devices, and flexible energy conversion applications. Flexible conducting films may also be used in non-invasive biomedical devices, where large deformations may be required to cope with body movements.

Electrodes for such electro-optical devices must also be transparent and flexible. Such electrodes and films not only require high transparency and conductivity, they also require flexibility in the conductive layer with respect to the substrate without loss of conductivity. Films with high conductivity and transparency characteristics are required to avoid undesirable voltage drops and the occurrence of Joule heating in the films, especially in current based devices such as organic light emitting diodes and solar cells.

Early attempts at producing transparent conductive films used indium tin oxide (ITO) as the conductive layer in transparent electrodes. However, device flexibility and performance are quite limited in ITO based films and electrodes. Traditional transparent conducting films (TCF) such as indium tin oxide (ITO) are not suitable for the flexible electronics technologies due to poor mechanical flexibility, and inconsistent transmittance near UV-VIS-NIR spectrum.

ITO films can also exhibit very high sheet resistance when deformed, even with very low applied compressive stresses. ITO films are brittle and crack. This results in a major bottleneck in the flexible electronic industry for high performance optoelectronic devices.

Several nanomaterials such as nanowires, conducting polymers, metal polymer layered hybrids, and carbon nanotubes have shown some potential as an ITO replacement. However, these materials are incapable of replacing ITO because of performance limitations. For example, CNTs and metallic nanowires suffer from long term instability, poor film uniformity, and high contact resistance. Conducting polymers and metal hybrids are well known for their large sheet resistances (Rₑ).

Graphene based transparent conductive films have also been investigated as a replacement to ITO to enhance the flexibility of thin film electrodes and devices. Unfortunately, large scale graphene synthesized by different methods results in crystalline graphene domains separated by grain boundaries, carbon vacancies, hexagonal lattice defects and random structural ripple distributions over large areas. These defects, ripples and grain boundaries in graphene sheets, along with substrate induced interfacial trap charges, react as carrier scattering centers and drastically reduce carrier mobility.

Accordingly, there is a need for flexible transparent films and electrodes with excellent optical transparency, electrical conductivity, and conductive layer flexibility. A need also exists for a method which renders a low cost, scalable process for producing flexible transparent films and electrodes for use in optical-electrical devices.

### BRIEF SUMMARY

The present technology provides flexible, conductive graphene-polymer nanocomposites and tunable methods of fabrication that employ improved stacking methods, layer-by-layer mixed chemical doping strategies, and the integration of other mechanically flexible transparent conducting materials. The graphene-polymer nanocomposite provides a useful alternative to inflexible ITO thin films currently used in the flexible electronics market.

Traditional transparent conducting films (TCF) such as indium tin oxide (ITO) are not particularly suitable for the flexible electronics technology due to poor mechanical flexibility, and inconsistent transmittance near UV-VIS-NIR region. Inflexible ITO films are brittle and exhibit a dramatic increase in film resistance under applied compressive stress. However, a graphene-polymer nanocomposite according to the technology described herein shows nearly no change in the film resistance under applied compressive stresses up to 23 gigapascal.

Alternatively, conventional graphene films exhibit higher sheet resistance (Rₛ) due to carrier scattering from lattice defects. In one embodiment, the graphene-polymer nanocomposite may exhibit very low sheet resistance (15 ohm/sq) with more than 90% transmittance in UV-VIS-NIR. The graphene-polymer nanocomposite also shows uniform transmittance throughout the UV-VIS-NIR wavelength region.

The present technology provides a flexible, transparent, conducting, layered graphene-polymer nanocomposite that overcomes the difficulties in using ITO and graphene in flexible electronic technologies. The graphene-polymer nanocomposite incorporates highly crystalline, defect free, large area graphene and solution processable conductive polymer (PEDOT:PSS) materials in a layered nanocomposite structure.

Moreover, a unique parallel carrier conduction approach is used to reduce grain boundaries, carbon vacancies, lattice defects and structural ripple induced carrier scattering by integrating appropriate nanocomposite layer stacking and layer-by-layer chemical doping methods. The layered graphene-polymer nanocomposite exhibits resistance quenching by suppressing defect induced carrier scattering in graphene. The layer-by-layer mixed chemical doping methods also incorporate different doping species to enhance electrical and optical properties individually.

The surface morphology the nanocomposite film is also comparably smoother to graphene films regions. This could be beneficial for surface roughness sensitive optoelectronic devices where surface roughness plays a crucial role in device performance.

The synthesis of the graphene-polymer nanocomposite is conducted by chemical processes in order to provide mass production capabilities. Chemical doping of the graphene layers can be conducted by conventional spin coating and dip coating methods. Furthermore, the preferred conductive PEDOT:PSS polymer can be dispersed in a water based solution and can be spin coated on top of the stack of graphene layers in order to fabricate the graphene-polymer nanocomposite. The thickness of the polymer film can be optimized, but is preferably maintained in the range of 50 nm to 70 nm and particularly around 60 nm to decrease sheet resistance of the film while maintaining a transmittance of more than 90%. Chemical doping methods may optionally be applied to the top of the graphene-polymer nanocomposite or to the polymer layer to further reduce the polymer sheet resistance. These composites do not have the deficiencies of ITO films due to very low sheet resistance, higher than 90% transmittance and very high flexibility.

The fabrication methods with layer-by-layer mixed chemical doping can be adapted to produce a wide variety of layer graphene-polymer nanocomposites with selected sequences of materials and dopants and selected characteristics. For example, the methods allow control over the following composite morphology: 1) the type, number and quantity of applied graphene dopants; 2) the thickness of the polymer and graphene layers; 3) the number of doped graphene layers; 4) the sequence of doped graphene layers; 5) graphene layers with mixed or multiple dopants; 6) polymer layer doping; and 7) the thermal and other processing conditions.

High performance flexible transparent conducting devices using chemically doped graphene-polymer nanocomposites can be produced for a wide range of applications such as flexible touchscreen displays, flexible solar cells, and flexible light emitting diodes (LED), flexible electroluminescence devices.

According to one aspect of the technology, a graphene-polymer flexible transparent conducting nanocomposite is provided that suppresses carrier scattering induced from graphene grain boundaries, carbon vacancies, lattice defects and structural ripple in graphene films.

According to another aspect of the technology, a layer-by-layer mixed chemical doping method is provided incorporating different dopant species for resistance quenching while maintaining high optical transparency (>90% transmittance at 550 nm) in nanocomposite films comparable to ITO films.

Another aspect of the technology is to provide a conductive composite with substantial transmittance uniformity in the VIS-NIR range (300 nm to 1000 nm) compared to graphene, polymers and ITO films.

A further aspect of the technology is to provide a composite with significant reduction of the carrier coherent backscattering and consequent resistance quenching compared to pristine graphene and doped graphene films.

Another aspect is to provide a composite with high mobility and carrier density in the graphene-polymer nanocomposite.

Still another aspect of the technology is to provide a composite that exhibits an unchanged transmittance spectrum and negligible resistance change in the nanocomposite film up to 24 GPa applied stress compared to resistance change in ITO.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE SEVERAL VIEWS OF THE DRAWINGS

The technology described herein will be more fully understood by reference to the following drawings which are for illustrative purposes only:

FIG. 1 is a functional block diagram of a method for fabricating flexible, conductive polymer-graphene composites according to one embodiment of the technology.

FIG. 2A is a schematic cross-sectional view of a flexible graphene-polymer conducting layered nanocomposite with a single graphene sheet and polymer layer with a single doping structure.

FIG. 2B is a schematic cross-sectional view of a flexible graphene-polymer, conducting layered nanocomposite with a two graphene sheet stack and a mixed doping structure.

FIG. 2C is a schematic cross-sectional view of a flexible graphene-polymer, conducting layered nanocomposite with a three graphene sheet stack and a mixed doping structure.

FIG. 3 is a graph of transmittance spectra of graphene-polymer nanocomposite with different layered structures.

FIG. 4 is a graph of transmittance spectra with a comparison of compressed (24 GPa stress) and flat (without applied stress) graphene-polymer nanocomposite films and ITO films mounted on PET substrates.

### DETAILED DESCRIPTION

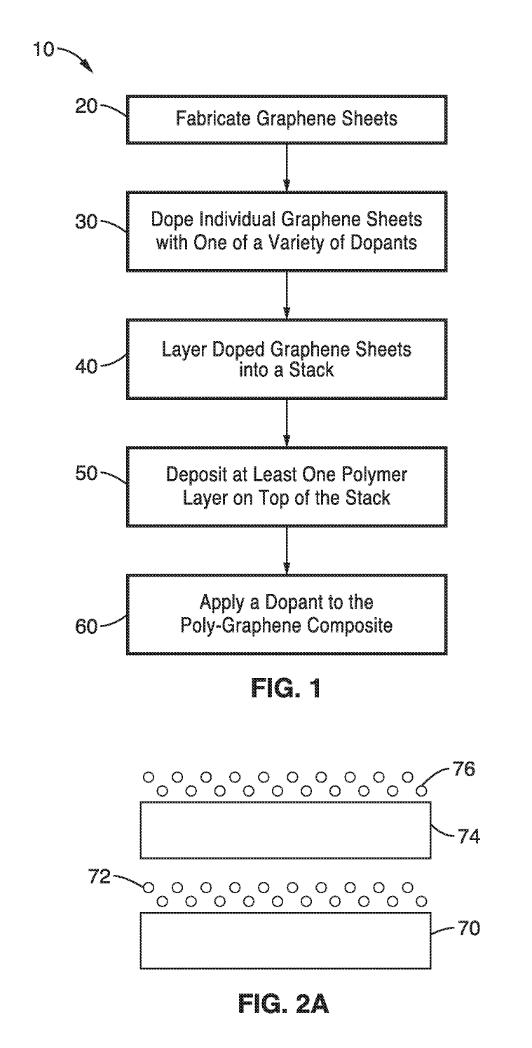

Referring more specifically to the drawings, for illustrative purposes, embodiments of flexible conductive thin films and methods of fabrication of films and electrode structures that can be placed on flexible substrates are generally shown. Embodiments of the technology are described generally in FIG. 1 through FIG. 3 to illustrate the characteristics and functionality of the device films and methods. It will be appreciated that the methods may vary as to the specific steps and sequence and the device films may vary as to structural details without departing from the basic concepts as disclosed herein. The method steps are merely exemplary of the order that these steps may occur. The steps may occur in any order that is desired, such that it still performs the goals of the claimed technology.

The fabrication of a flexible, transparent, conducting, layered graphene-polymer nanocomposite that exhibits resistance quenching by suppressing defect induced carrier scattering in graphene is generally illustrated in FIG. 1. The methods provide a layer-by-layer mixed chemical doping scheme that results in composites with low sheet resistance, high charge mobility and carrier density.

Turning now to FIG. 1, one embodiment of a method 10 for polymer-graphite composite thin film fabrication for use on a flexible polymeric substrate is shown schematically. The films that are produced from the methods shown in FIG. 1 can stand alone or they can be mounted on transparent, flexible substrates or fixed structures.

At block 20 of the method shown in FIG. 1, preferably low defect graphene sheets of desired dimensions are obtained or fabricated using one of several conventional techniques. For example, graphene may be produced by spin-coating aqueous dispersions of graphene oxide, or by vacuum-filtration of liquid-phase exfoliated graphene in highly volatile, non-toxic solvents such as isopropanol or ethanol. Other methods for fabricating single sheets of graphene with few vacancies or grain boundaries in the lattice sheet structure may also be used.

The graphene sheets are normally placed on a smooth, flat support surface during the formation steps of the composite. CVD grown single layer graphene sheets transferred on SiO₂ support substrates are particularly preferred.

The graphene sheets are then doped with one of a variety of dopants at block 30 of FIG. 1 to achieve resistance quenching or other work functions in the individual sheet. The functional and performance characteristics of each sheet can be modulated in part by the dopant or dopants that are selected as well as through thermal treatments of the graphene sheets before or after doping or sheet stacking.

The unique electronic band structure of graphene allows modulation of the charge carrier conduction and significant decrease in Rₛ by chemical doping with chemical dopants such as HNO₃, AuCl₃, bis(trifluoromethane)sulfonimide (TFSA) and other dopants.

The p-Type and n-type doping of the graphene sheet at block 30 can be achieved through surface transfer doping or substitutional doping. For example, individual or stacked graphene sheets can be effectively p-doped with nitric acid.

In the embodiment illustrated in FIG. 1, the graphene sheets are doped individually with a selected dopant at block 30 and then the doped sheets are then stacked. However, in an alternative embodiment, the graphene sheets are doped after each pristine graphene layer is added to the stack at block 40. In another alternative embodiment, all of the graphene layers are stacked at block 40 and then the stack of graphene layers is chemically doped with one or more dopants.

The preferred number of layers of graphene sheets, doped individually or collectively, that are stacked at block 40 is preferably within the range of 1 to 3 graphene sheets. For applications where high transparency is not essential, more graphene sheets can be used in the formation of the doped graphene stack.

In one embodiment, the stack of doped graphene sheets is subject to one or more thermal heat treatments for a period of time to anneal the sheet structure prior to the application of the polymer layer at block 50. In another embodiment, each individually doped graphene sheet receives thermal treatment before stacking.

At block 50, the stack of doped graphene sheets has at least one polymer layer of one or more monomers/polymers deposited on to the top surface of the stack. The polymer that is selected for the polymer layer is preferably a conductive polymer such as PEDOT:PSS that is also transparent. In one embodiment, a conductive polymer layer and a non-conductive polymer layer is applied at block 50.

The thickness of the polymer film that is applied at block 50 is also determined. The thickness of the polymer layer can be optimized for transmittance, conductance and stability. The overall thickness of the polymer-graphene composite can also be optimized for flexibility to avoid delamination when the composite is coupled with a flexible substrate.

The polymer layer that is applied to the stack to form a polymer-graphene composite at block 50 can optionally be doped to improve conductivity (i.e. reduce sheet resistance) with chemical doping at block 60 of FIG. 1. In one embodiment, the whole polymer-graphene composite is subject to chemical doping at block 60.

It can be seen that this fabrication process can be adapted to produce a number of structures that incorporate highly crystalline, defect free, large area graphene and solution processable conductive polymer (PEDOT:PSS) materials in a layered nanocomposite structure. Moreover, the parallel carrier conduction approach reduces grain boundaries, carbon vacancies, lattice defects and structural ripple induced carrier scattering observed with pristine graphene.

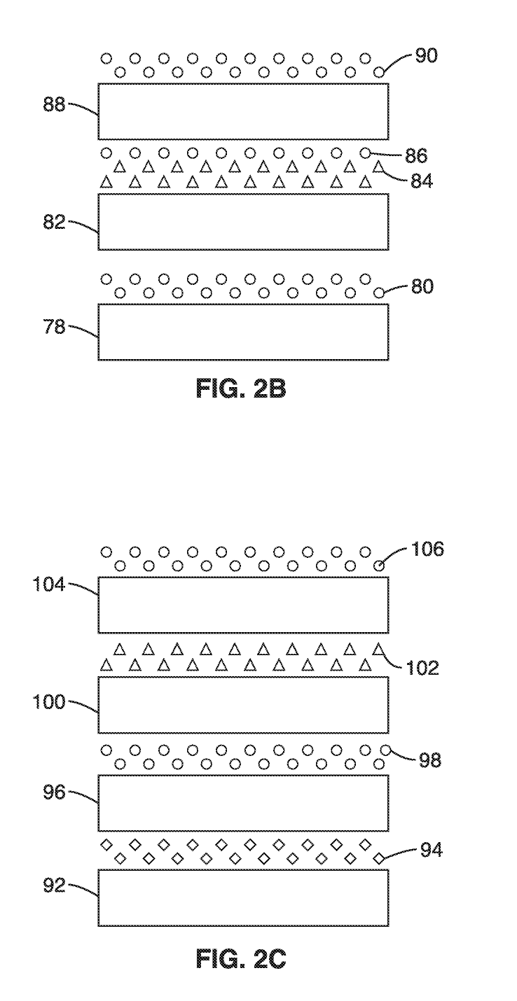

The variety of different polymer-graphene composite structures that can be produced with the methods are illustrated in FIG. 2A to FIG. 2C. The functional characteristics and morphology of the polymer-graphene composite produced by the methods can be tuned by the selection of the number of graphene sheets used in the composite as well as the identity and sequence of dopants, graphene sheets, and thermal processing etc.

One simple polymer-graphene composite structure that can be produced by the methods is shown schematically in FIG. 2A. In this embodiment, a single graphene sheet 70 is used. The graphene sheet 70 is doped with a dopant 72 and a polymer layer 74 is deposited on to the doped sheet 70. The polymer layer 74 can also be doped with a second dopant 76 to complete the structure.

In another embodiment, the graphene sheet dopant 72 and the polymer dopant 76 are the same. In a further embodiment, the graphene sheet layer 70 and the polymer 74 layer are doped with the same dopant at the same time after the formation of the polymer-graphene composite to complete the structure.

A polymer-graphene composite with two graphene sheets is illustrated schematically in FIG. 2B. In this embodiment, the first graphene sheet 78 is chemically doped with a first dopant 80. A second graphene sheet 82 that has been doped with a second dopant 84 and a third dopant 86 is stacked on top of the first doped graphene sheet 78.

A polymer layer 88 is then deposited on to the top of the stacked doped graphene layers. The polymer layer 88 is also doped with a fourth dopant 90 in this illustration. It can be seen from this illustration that the dopants that are applied can all be different or combinations of different dopants to produce desired characteristics. For example, in one embodiment, the dopant 80 of the first graphene layer is the same as dopant 90 that was applied to the polymer layer 88. In another embodiment, the dopant 86 is the same as the first graphene dopant 80. In another embodiment, the graphene dopants 80, 84 and the polymer dopant 90 are the same dopant material and dopant 86 is omitted.

In FIG. 2C, a polymer-graphene composite with three graphene sheets and mixed doping is depicted schematically. In this illustration, each graphene layer and polymer layer is doped with a different chemical dopant. A graphene stack is formed with a first graphene sheet 92 that is doped with a first dopant 94; a second graphene sheet 96 doped with a second dopant 98, and a third graphene sheet 100 doped with a third dopant 102. A polymer layer 104 is deposited over the top of the stack and optionally doped with a fourth dopant 106.

It is apparent that the dopants that are applied in this structure can be the same or any combination of the four dopants shown in FIG. 2C. For example, in one embodiment, the dopant 94 of the first graphene sheet 92 and the dopant 98 of the second graphene sheet 96 and the dopant 102 of the third graphene sheet 100 are the same and the dopant 106 of the polymer layer 104 is different. Accordingly, polymer-graphene composite structures with one, two, three or four different types of doping applications can be produced with the methods illustrated in FIG. 2A to FIG. 2C. Individual graphene layers and the polymer layer may also be doped with more than one dopant as illustrated in FIG. 2B.

The technology described herein may be better understood with reference to the accompanying examples, which are intended for purposes of illustration only and should not be construed as in any sense limiting the scope of the technology described herein as defined in the claims appended hereto.

### Example 1

In order to demonstrate the operational principles of the transparent flexible, and conductive polymer-graphene composite fabrication methods and devices, various composite films were fabricated and evaluated to demonstrate control over the film structure and functional characteristics. The method of fabrication of flexible conductive composites as generally depicted in FIG. 1 was preformed and the composite properties and composite performance were evaluated.

Single layered graphene was synthesized using low pressure chemical vapor deposited (LP-CVD) system on 100 μm thick Cu foil. First, Cu foil was annealed for 5 hours at 1020° C. under 145 standard cubic centimeters per minute (sccm) argon and 29 sccm hydrogen gas mixture followed by chemical polishing using a Cu etchant solution (CE-100, Transene Company, Inc.).

Second, graphene growth was conducted at 1000° C. for 30 min under 500 mTorr with a 113 sccm methane and 12 sccm hydrogen gas mixture. Graphene sheets were transferred on to a target substrate using a polymethyl methacrylate (PMMA) thin film and deionized water method. Third, chemical doping of the graphene sheets was performed with a 30 mM TFSA and AuCl₃ dopants that were dispersed in nitromethane (Sigma Aldrich).

Fourth, a highly conductive PEDOT:PSS polymer solution (Sigma Aldrich) was spin coated on top of the doped graphene layers for graphene-polymer nanocomposite synthesis. Each nanocomposite layer was annealed at 80° C. for 10 min under atmospheric conditions during the synthesis process. A 30-watt oxygen plasma was used for 20 min for Hall-bar device patterning of the nanocomposite layers. Then 5 nm Cr and 100 nm Au thin films were deposited using e-beam metal evaporation process for device contacts.

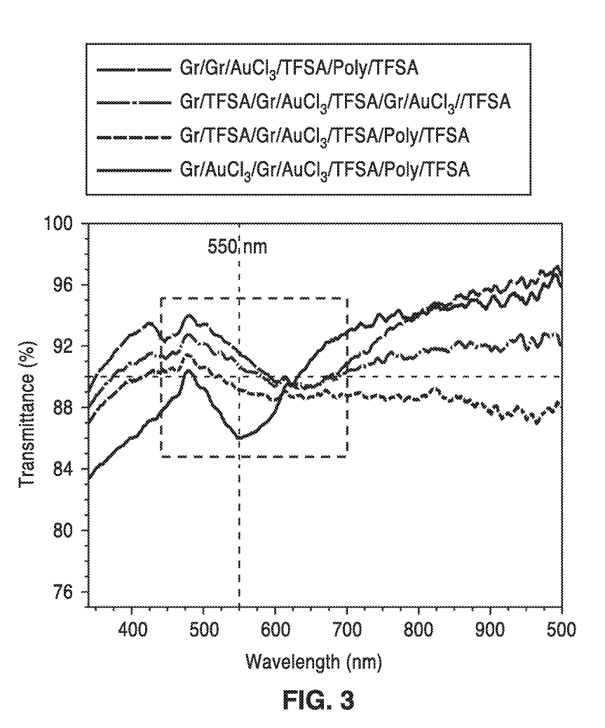

Thereafter, composites with two and three doped graphene sheets were fabricated and evaluated as illustrated in FIG. 3. The layer-by-layer mixed chemical doping methods incorporating different doping species to enhance electrical and optical properties individually were evaluated. Transmittance, sheet conduction and mechanical flexibility evaluations of a number of composites with different polymer layer thicknesses, different numbers of graphene sheets, different dopants and flexible substrates where performed.

### Example 2

The characteristics of polymer-graphene composites with single graphene sheets with different polymer thicknesses and dopants. Initially, the transmittance spectra of graphene and polymer (PEDOT:PSS) films with different thicknesses transferred on top of a PET substrate were evaluated. Single layer graphene sheets produced around 97.5% transmittance at 550 nm. Two and three layers of stacked graphene films resulted in a reduction in transmittance around 94.8% and 92.3% respectively as expected. In comparison, 46 nm, 241 nm and 1260 nm thick PEDOT:PSS films show transmittance in the range of 96.7%, 91.7% and 81.3% respectively at 550 nm. It was observed that transmittance in graphene decreased slightly below 500 nm and transmittance in PEDOT:PSS reduced drastically in NIR regions.

Electrical sheet resistances of these graphene sheets and PEDOT:PSS films were also compared. The Rₛ and transmittance of both decreased with increasing thickness of the graphene and PEDOT:PSS films. Optical micrographs of the single layered graphene film, thin (57 nm) and thick (1260 nm) PEDOT:PSS films on PET substrate were obtained. The thickness of the polymer (PEDOT:PSS) thin films were measured by profilometer height profile that enabled the variations in transmittance and Rₛ as a function of film thickness to be summarized.

Polymer films with different thicknesses were prepared in the range from 46 nm to 1260 nm. Decreasing transmittance and Rₛ were observed with exponential increase in the film thickness. For example, the 46 nm film exhibited 96.7% transmittance and 353 Ω/sq Rₛ, while 1260 nm film showed 81.3% transmittance and Rₛ decreased to 69 Ω/sq.

The unique electronic band structure of graphene allows modulation of the charge carrier conduction and significant decrease in Rₛ by chemical doping. Chemical dopants such as HNO₃, AuCl₃, bis(trifluoromethane)sulfonimide (TFSA) were investigated for use with graphene films. Various doping methods were compared for doping the graphene-polymer nanocomposite and optimize the effective decrease in film Rₛ while maintaining the 90% transmittance for practical applications.

It was demonstrated that a 30 mM dopant concentration was sufficient to achieve Rₛ saturation. Therefore, a 30 mM dopant (AuCl₃ and TFSA) concentration in nitromethane solution was spin coated (4000 rpm for 2 min) on top of the films followed by hot plate annealing at 80° C. for 10 minutes.

The transmittance spectra of single layered doped graphene films were compared with pristine graphene and doped graphene-polymer nanocomposites. The transmittance of the HNO₃, AuCl₃, and TFSA doped single layered graphene films showed similar values near 550 nm but varied slightly around 350 nm.

Transmittance of the AuCl₃ doped single layered graphene dramatically decreased near 300 nm which could be due to the formation of gold nanocluster from Au0 and Au³⁺ ions. These nanoclusters significantly decreased transmittance in AuCl₃ doped single layered graphene coated with 46 nm polymer film throughout UV-VIS-NIR region.

Intrinsically pristine graphene film resulted in 97.6% transmittance and about a 490 Ω/sq sheet resistance. The Rₛ could be dramatically reduced without altering transmittance significantly by chemical doping using HNO₃, AuCl₃, and TFSA up to 348 Ω/sq, 257 Ω/sq, and 181 Ω/sq respectively. Top layers with different polymer film thicknesses were used on top of the chemically doped graphene layer to further an increase in R. The 46 nm polymer results in 93% transmittance and 81 Ω/sq Rₛ and decreased with increasing polymer thickness up to 27 Ω/sq in 112 nm. Consequently, transmittance of the film decreased with increasing polymer thickness.

One of the major advantages in the graphene-polymer nanocomposite is the transmittance uniformity over broad range of wavelengths. Although both graphene and PEDOT:PSS (polymer) films individually demonstrated irregular transmittance spectra over a spectral window of between 300 nm to 1000 nm, transmittance variation was significantly reduced in the graphene-polymer nanocomposite films.

Transmittance can be maximized to approximately (91.7%) at around a 550 nm wavelength, ideally suited for large number of optoelectronic applications.

### Example 3

To further demonstrate the device functions and structure options, graphene-polymer composites with multiple graphene sheets, different dopants and polymer films with different thicknesses were produced and compared with conventional ITO films.

Since sheet resistance and transmittance decrease with increasing film thickness in graphene and polymer thin films, the transmittance and resistance of the composites can be optimized. The film thickness adequate for 90% transmittance resulted in around 150 Ω/sq sheet resistance both in the individual or few layered graphene and PEDOT:PSS films.

Sheet resistance was reduced by chemical doping of the graphene sheets. The sheet resistance was reduced in single layered graphene from 491 Ω/sq to 348 Ω/sq, 257 Ω/sq, and 181 Ω/sq without altering transmittance using HNO₃, AuCl₃, and TFSA doping respectively. It should be noted that the single layered graphene doped by HNO₃ results marginally higher transmittance of 98.1% compare to pristine graphene could be due to the etching and defect generation by the strong HNO₃ acid solution.

In comparison, AuCl₃ doping did not increase defects in graphene. However, AuCl₃ doping did result in the aggregation of gold Au0 and Au³⁺ ions on the film surface. These aggregated nanoparticles scatter with incident light and reduce film transmittance.

Graphene-polymer nanocomposites of different thicknesses and layer/dopant compositions were also produced and evaluated. Graphene-polymer flexible conducting layered nanocomposites with different mixed doping structures and their corresponding transmittance (at 550 nm) and sheet resistance values are shown in Table 1.

As illustrated in Table 1, a variety of composites with different numbers of sheets, dopants and doped sheet sequences can be produced. For example, graphene/AuCl₃/graphene/AuCl₃/polymer structures were prepared by changing polymer thickness from 46 nm to 100 nm. Although the Rₛ can be reduced from 81 Ω/sq to 27 Ω/sq using this method, the transmittance of the sample reduced drastically from 93% to 82.6% respectively that could be due to the gold nanoparticle formation in the film.

This suggested that the AuCl₃ doping method results in an efficient decrease in the film sheet resistance. However, considerable decrease in the film transmittance below 90% may be a major disadvantage to the use of this dopant.

By comparison, the TFSA doping method reduced the sheet resistance Rₛ without a significant compromise in transmittance. The TFSA doped graphene polymer nanocomposite in the structure of graphene/TFSA/graphene/TFSA/polymer was compared with the AuCl₃ doped structure using similar polymer thickness variations (46 nm to 100 nm). The TFSA doped nanocomposite had a 90.2% transmittance and Rₛ around 51 Ω/sq. The Rₛ of this structure can be further reduced up to 37 Ω/sq by increasing nanocomposite thickness. However, transmittance was reduced to lower than 90% (88%). It was evident that the TFSA doping method was beneficial for decreasing electrical Rₛ without compromising much of optical transmittance in nanocomposite films compared to the AuCl₃ doping method.

Therefore, a mixed chemical doping method was developed incorporating TFSA doping (advantageous for optical transmittance) and AuCl₃ doping (beneficial for lower Rₛ) respectively. This doping strategy enables an Rₛ of around 15 Ω/sq with 90.7% transmittance in a graphene/TFSA/graphene/AuCl₃/TFSA/polymer/TFSA nanocomposite structure.

Increasing the nanocomposite film thickness from this point could decrease Rₛ further (14 Ω/sq). However, transmittance would also be reduced drastically to less than 90% (86%), making it potentially undesirable for some optoelectronic applications.

The transmittance spectrum and resistance of composites with mixed doping were also compared to optimized for the lowest Rₛ while keeping >90% transmittance as shown in FIG. 3. In one illustration, a graphene-polymer nanocomposite with two layered doped graphene sheets stacked together with 57 nm thick PEDOT:PSS film on top was evaluated. Single use of AuCl₃ doping in a nanocomposite structure was demonstrated with a two graphene sheet graphene/graphene/AuCl₃/TFSA/polymer/TFSA nanocomposite structure. This structure demonstrated high transmittance (91.5%) due to less nanocluster formation from Au0 and Au³⁺ ions. However, the Rₛ was not considerably low (35 Ω/sq) compared to ITO. Moreover, the transmittance variation in this structure was obtained around 8.4%.

TFSA doping was introduced between graphene layers while keeping other layers identical in a nanocomposite structure with the sequence of graphene/TFSA/graphene/AuCl₃/TFSA/polymer/TFSA in order to decrease the sheet resistance further without compromising transmittance below 90% as shown in FIG. 3. Encouraging resistance quenching resulted in the Rₛ decreasing to 15 Ω/sq and transmittance around 90.7%, which was comparable with conventional ITO. Accordingly, the sheet resistance in the doped nanocomposite can be significantly quenched compared to pristine graphene and polymer films.

Furthermore, transmittance variations were significantly reduced to 3.6% in this structure resulting in a maximum (92.7% transmittance at 480 nm) and minimum (89.3% transmittance at 650 nm) that are both in the visible wavelength regions. Low Rₛ (comparable to ITO), high transmittance (>90%), low transmittance variations (<4%), and transmittance maximum/minimum in the visible region highlight the advantages of this nanocomposite structure.

Similarly, two time use of AuCl₃ doping in graphene sheets in a graphene/AuCl₃/graphene/AuCl₃/TFSA/polymer/TFSA nanocomposite structure demonstrated a comparable Rₛ (17.8 Ω/sq) with transmittance reduced below 90% (89.1%).

Three-layered graphene in the nanocomposite structures were also prepared and evaluated. A structure of with a layer and dopant sequence of graphene/TFSA/graphene/AuCl₃/TFSA/graphene/AuCl₃/polymer/TFSA resulted in significant reduction in film transmittance up to 86% and resulted in a similar Rₛ (14 Ω/sq) as shown in FIG. 3.

Accordingly, the graphene-polymer layered nanocomposites exhibits improved optoelectronic properties compared to their close counterparts such as graphene, polymer, and ITO films for flexible thin conductive film applications.

### Example 4

The low temperature magnetoresistance properties of the graphene-polymer nanocomposite were also evaluated. Variations in longitudinal resistance (Rₓₓ) with temperature (300 K to 2 K) without a magnetic field for the doped graphene-polymer nanostructures (DGPN), doped graphene structures (DG), and pristine graphene (PG) device structures were demonstrated. Comparison of Rₓₓ and weak localization effect (Rₓₓ near B=0) and carrier density variations with applied magnetic field (over ±2 tesla) and temperature (2 K to 300 K) were also evaluated.

Low temperature transport measurements were conducted by pattering DGPN, DG, and PG samples in Hall-bar geometry on a SiO₂/Si substrate. Transport measurements were conducted by pattering DGPN, DG, and PG samples in Hall-bar geometry on SiO₂/Si substrate.

Variations in longitudinal resistance (Rₓₓ) in the temperature range from 300 K to 2 K without the presence of the magnetic field were observed. At 300 K, pristine graphene (PG) devices showed Rₓₓ close to 570Ω, whereas Rₓₓ reduced to 300Ω in doped graphene (DG) due to chemical doping and further resistance quenching was observed (102Ω) in nanocomposite (DGPN) similar to Rₛ trends.

The carrier coherent backscattering caused by the weak localization effects were significantly reduced in doped graphene-polymer nanocomposite (DGPN) samples. This was manifested by the reduction of weak localization peak height (at B=0) in DGPN up to 0.5% compared to 4.25% in PG and 1.2% in DG samples.

These results strongly suggest that the reduction in carrier scattering and consequent resistance quenching in DGPN are due to the reduction of grain boundaries, carbon vacancies, lattice defects and structural ripple related carrier scattering processes.

Negligible variations in carrier mobility with increasing temperature in PG and DG samples were observed. In contrast, significantly large mobility variation was observed in DGPN samples ranging from 2490 cm²/Vs at 300 K to 5420 cm²/Vs at 2 K temperature under fixed magnetic field (B=0). Carrier mobility increased in DGPN with decreasing temperature and reached its maximum (7000 cm²/Vs, 2.3 times higher than PG, 1.4 times higher than DG) near 2 K under a +2 tesla magnetic field. These increments in carrier mobility (both maximum and minimum) suggest significant quenching of carrier scattering in DGPN compared to doped and pristine graphene samples.

The improved carrier conduction in doped graphene and doped nanocomposite samples compared to pristine graphene indicate that surface conductance of the chemically doped samples could be higher than pristine graphene. This clearly demonstrates that surface conductance the graphene films can be increased by the using mixed chemical doping methods.

### Example 5

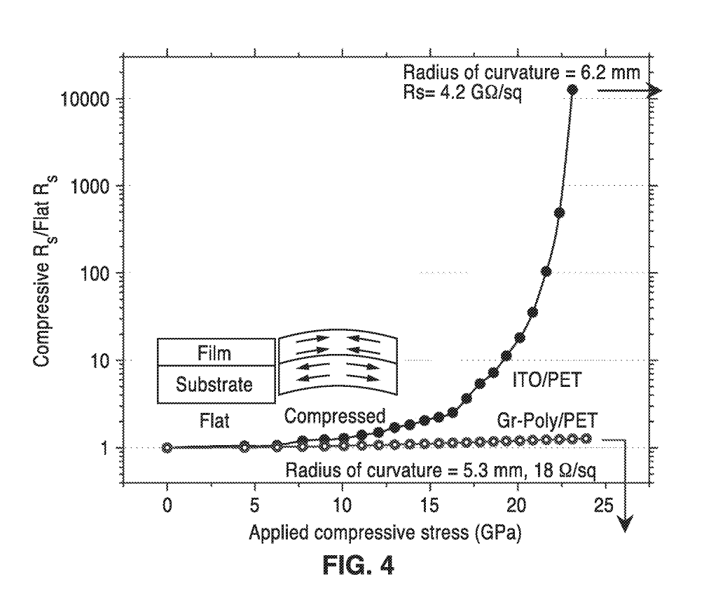

To demonstrate the mechanical flexibility of the composites without loss of conduction, graphene-polymer nanocomposites and ITO films were mounted to a flexible substrate and Rₛ compared under applied compressive stress. Changes in the film sheet resistance (final compressive Rₛ/initial flat Rₛ) under applied compressive stress up to 23 GPa in a 100 nm thick ITO film and DGPN mounted on a flexible PET substrate were evaluated. Samples were rolled up in different curvatures using cylindrical tubes to apply fixed compressing stress on the attached film. Bottom inset of FIG. 4 is a schematic illustration of the flat and compressed states of thin films on a flexible substrate.

Poor mechanical flexibility of thin film ITO is among the major restrictions in its use in flexible electronics applications. Significant resistance change occurs in ITO films under stress. Optical micrographs of the compressed 100 nm ITO film on PET substrate (under 23 GPa compressive stress) depicted clear mechanical crack lines in the ITO film.

A comparison of the changes in the film sheet resistance (final compressive Rₛ/initial flat Rₛ) under applied compressive stress up to 23 GPa in 100 nm thick ITO film and DGPN on a flexible PET substrate is illustrated in FIG. 4. Initially, it can be seen from the graph that the ITO and DGPN films demonstrate approximately 10 Ω/sq and 15 Ω/sq sheet resistances respectively. The change in ITO sheet resistance remained small (1.07 times) up to very low applied compressive stress (6 GPa). However, resistances increased sharply up to 12.6×10³ times at 23 GPa.

In the later stages of flexion, the ITO film under applied stress produced very high Rₛ values of 4.2 GO/sq, suggesting significant damage to the film. Clear mechanical cracks were observed under optical micrographs and AFM micrographs with nearly 80 nm crack depth under 23 GPa applied compressive stress. This was compared with ITO film deposited on flat PET substrate without any applied stress in which no cracks were observed.

In comparison, the nanocomposite film shows only 1.2 times change in the sheet resistance under applied stress up to 24 GPa. AFM morphology of the compressed DGPN (under 24 GPa applied stress) did not revealed any mechanical crack formation. Furthermore, compressed DGPN sample shows a nearly identical transmittance spectrum compare to flat DGPN without any applied stress. These results highlight very high mechanical stability of the graphene polymer nanocomposite film with nearly unchanged transmittance spectrum, and nearly unaltered sheet resistance up to 24 GPa applied stress.

Embodiments of the present technology may be described herein with reference to flowchart illustrations of methods and systems according to embodiments of the technology, and/or procedures, algorithms, steps, operations, formulae, or other computational depictions, which may also be implemented as computer program products. In this regard, each block or step of a flowchart, and combinations of blocks (and/or steps) in a flowchart, as well as any procedure, algorithm, step, operation, formula, or computational depiction can be implemented by various means, such as hardware, firmware, and/or software including one or more computer program instructions embodied in computer-readable program code. As will be appreciated, any such computer program instructions may be executed by one or more computer processors, including without limitation a general purpose computer or special purpose computer, or other programmable processing apparatus to produce a machine, such that the computer program instructions which execute on the computer processor(s) or other programmable processing apparatus create means for implementing the function(s) specified.

Accordingly, blocks of the flowcharts, and procedures, algorithms, steps, operations, formulae, or computational depictions described herein support combinations of means for performing the specified function(s), combinations of steps for performing the specified function(s), and computer program instructions, such as embodied in computer-readable program code logic means, for performing the specified function(s). It will also be understood that each block of the flowchart illustrations, as well as any procedures, algorithms, steps, operations, formulae, or computational depictions and combinations thereof described herein, can be implemented by special purpose hardware-based computer systems which perform the specified function(s) or step(s), or combinations of special purpose hardware and computer-readable program code.

From the description herein, it will be appreciated that that the present disclosure encompasses multiple embodiments which include, but are not limited to, the following:

1. A transparent, flexible conductive nanocomposite, comprising: (a) a stack of one or more chemically doped graphene sheets; and (b) a polymer layer of at least one conductive polymer formed on a top surface of the stack of doped graphene sheets; (c) wherein the resultant graphene-polymer nanocomposite material suppresses carrier scattering induced from graphene grain boundaries, carbon vacancies, lattice defects and structural ripples in the graphene films.

2. The nanocomposite of any preceding or following embodiment, wherein the polymer layer comprise poly(3,4-ethylenedioxythiophene) polystyrene sulfonate, (PEDOT:PSS).

3. The nanocomposite of any preceding or following embodiment claim 1, wherein the polymer layer comprises a doped conductive polymer layer.

4. The nanocomposite of any preceding or following embodiment, wherein the graphene sheet is doped with a dopant selected from the group of dopants consisting of HNO₃, AuCl₃ and bis(trifluoromethane)sulfonimide (TFSA).

5. The nanocomposite of any preceding or following embodiment, further comprising: a second doped graphene sheet coupled to the stack of doped graphene sheets; the second doped graphene sheet having a dopant that is different from the doped graphene sheets of the stack.

6. The nanocomposite of any preceding or following embodiment, further comprising: a second doped graphene sheet with a second dopant coupled to the stack of doped graphene sheets; and a third doped graphene sheet with a third dopant coupled to the second graphene sheet; wherein the dopants individually enhance electrical and optical properties of a final nanocomposite.

7. The nanocomposite of any preceding or following embodiment, wherein the first, second and third graphene sheet are doped with a dopant selected from the group of dopants consisting of HNO₃, AuCl₃ and bis(trifluoromethane)sulfonimide (TFSA).

8. The nanocomposite of any preceding or following embodiment, wherein the polymer layer comprises a doped conductive polymer layer doped with a fourth dopant.

9. The nanocomposite of any preceding or following embodiment, wherein the fourth dopant comprises bis(trifluoromethane)sulfonimide (TFSA).

10. A method of fabricating a graphene-polymer nanocomposite material, the method comprising: (a) fabricating a plurality of single layered graphene sheets; (b) doping individual graphene sheets with at least one dopant species; (c) stacking the individual doped graphene sheets into a stack of doped graphene sheets; and (d) depositing a polymer layer over the stack of individually doped graphene sheets to form a graphene-polymer nanocomposite material; (e) wherein the doping comprises layer-by-layer mixed chemical doping that incorporates different doping species to enhance electrical and optical properties individually.

11. The method of any preceding or following embodiment, wherein the individual graphene sheet is doped with a dopant species selected from the group of dopant species consisting of HNO₃, AuCl₃ and bis(trifluoromethane)sulfonimide (TFSA).

12. The method of any preceding or following embodiment, wherein the polymer layer comprises poly(3,4-ethylenedioxythiophene) polystyrene sulfonate, (PEDOT:PSS).

13. The method of any preceding or following embodiment, further comprising: selecting a sequence of the graphene sheets doped with different dopants to form a sequenced stack of doped graphene sheets.

14. The method of any preceding or following embodiment, further comprising: thermally treating the doped graphene sheets before depositing the polymer layer.

15. The method of any preceding or following embodiment, further comprising: doping the graphene-polymer nanocomposite material to increase carrier density and reduce sheet resistance.

16. The method of any preceding or following embodiment, wherein the graphene-polymer nanocomposite material is doped with a bis(trifluoromethane)sulfonimide (TFSA) dopant.

17. The method of any preceding or following embodiment, further comprising: coupling an undoped graphene sheet to a bottom surface of the stack.

18. A method of fabricating a graphene-polymer nanocomposite material, the method comprising: (a) fabricating a plurality of single layered graphene sheets; (b) doping individual graphene sheets with at least one of a first dopant species, a second dopant species or a third dopant species; (c) selecting a sequence of the graphene sheets doped with different dopants; (d) stacking the individual doped graphene sheets to form a sequenced stack of doped graphene sheets with a top and bottom surface; and (e) depositing a polymer layer over the top surface of the sequenced stack of individually doped graphene sheets to form a graphene-polymer nanocomposite material; (f) wherein the doping comprises layer-by-layer mixed chemical doping that incorporates different doping species to enhance electrical and optical properties individually.

19. The method of any preceding or following embodiment, further comprising: doping the graphene-polymer nanocomposite material to increase carrier density and reduce sheet resistance.

20. The method of any preceding or following embodiment, further comprising: coupling an undoped graphene sheet to the bottom surface of the sequenced stack of doped graphene sheets.

21. The method of any preceding or following embodiment, further comprising: thermally treating the doped graphene sheets before depositing the polymer layer.

22. The method of any preceding or following embodiment, wherein the individual graphene sheets are doped with a dopant species selected from the group of dopant species consisting of HNO₃, AuCl₃ and bis(trifluoromethane)sulfonimide (TFSA).

23. The method of any preceding or following embodiment, wherein the first, second or third dopants comprise a mixture of two dopant species.

24. A graphene-polymer nanocomposite material incorporating a chemically doped graphene-polymer heterostructure.

25. The nanocomposite material of any preceding or following embodiment, wherein the nanocomposite material is configured as a flexible and transparent film for application in fabricating electronic devices selected from the group of devices consisting of flexible touchscreen displays, flexible solar cells, flexible light emitting diodes (LED), flexible electroluminescence devices, other devices requiring a transparent film, and combinations thereof.

26. The nanocomposite material of any preceding or following embodiment, wherein the material suppresses carrier scattering induced from graphene grain boundaries, carbon vacancies, lattice defects and structural ripple in graphene films.

27. The nanocomposite material of any preceding or following embodiment, wherein the material exhibits transmittance uniformity of about 3.6% in the VIS-NIR range of about 300 nm to about 1000 nm.

28. The nanocomposite material of any preceding or following embodiment, wherein the material exhibits carrier coherent backscattering and consequent resistance quenching of less than about 0.5%.

29. The nanocomposite material of any preceding or following embodiment, wherein the material exhibits mobility of about 7×10³ cm²/Vs and carrier density of about 4×10¹³ cm⁻².

30. The nanocomposite material of any preceding or following embodiment, wherein the material exhibits unchanged transmittance spectrum and resistance change of about 1.2 times at up to about 24 GPa applied stress.

31. A method of fabricating a graphene-polymer nanocomposite material, the method comprising: (a) fabricating a plurality of monolayers of graphene film; (b) doping the monolayers of graphene film to increase carrier density and reduce sheet resistance; (c) depositing a polymer layer over the monolayers of graphene film to a graphene-polymer nanocomposite material; and (d) doping the graphene-polymer nanocomposite material to increase carrier density and reduce sheet resistance; (e) wherein the doping comprises layer-by-layer mixed chemical doping that incorporates different doping species to enhance electrical and optical properties individually.

32. The method of any preceding or following embodiment, wherein the resultant graphene-polymer nanocomposite material suppresses carrier scattering induced from graphene grain boundaries, carbon vacancies, lattice defects and structural ripple in graphene films.

33. The method of any preceding or following embodiment, wherein the resultant graphene-polymer nanocomposite material exhibits transmittance uniformity of about 3.6% in the VIS-NIR range of about 300 nm to about 1000 nm.

34. The method of any preceding or following embodiment, wherein the resultant graphene-polymer nanocomposite material exhibits carrier coherent backscattering and consequent resistance quenching of less than about 0.5%.

35. The method of any preceding or following embodiment, wherein the resultant graphene-polymer nanocomposite material exhibits mobility of about 7×10³ cm²/Vs and carrier density of about 4×10¹³ cm⁻².

36. The method of any preceding or following embodiment, wherein the resultant graphene-polymer nanocomposite material exhibits unchanged transmittance spectrum and resistance change of about 1.2 times at up to about 24 GPa applied stress.

As used herein, the singular terms “a,” “an,” and “the” may include plural referents unless the context clearly dictates otherwise. Reference to an object in the singular is not intended to mean “one and only one” unless explicitly so stated, but rather “one or more.”

As used herein, the term “set” refers to a collection of one or more objects. Thus, for example, a set of objects can include a single object or multiple objects.

As used herein, the terms “substantially” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

TABLE 1

| | | Sheet |
|---|---|---|
| | Transmittance at | Resistance |
| Mixed Doping Structure | 550 nm (%) | (Ω/sq) |
| Gr/Au/Gr/Au/TSFA/Poly/TSFA | 89.1 | 17.8 |
| Gr/Gr/Au/TFSA/Poly/TSFA | 91.5 | 34.9 |
| Gr/TFSA/Gr/Au/TFSA/Poly/TFSA | 90.7 | 15.1 |
| Gr/TFSA/Gr/TFSA/Gr/Au/Poly/TFSA | 86.1 | 14.1 |

What is claimed is:

1. A transparent, flexible conductive nanocomposite, comprising:
(a) a stack of one or more chemically doped graphene sheets; and
(b) a polymer layer of at least one conductive polymer formed on a top surface of the stack of doped graphene sheets;
(c) wherein the resultant graphene-polymer nanocomposite material suppresses carrier scattering induced from graphene grain boundaries, carbon vacancies, lattice defects and structural ripples in the graphene films.

2. The nanocomposite of claim 1, wherein said polymer layer comprise poly(3,4-ethylenedioxythiophene) polystyrene sulfonate (PEDOT:PSS).

3. The nanocomposite of claim 1, wherein said polymer layer comprises a doped conductive polymer layer.

4. The nanocomposite of claim 1, wherein said graphene sheet is doped with a dopant selected from the group of dopants consisting of HNO₃, AuCl₃ and bis(trifluoromethane)sulfonimide (TFSA).

5. The nanocomposite of claim 1, further comprising:
a second doped graphene sheet coupled to the stack of doped graphene sheets;
said second doped graphene sheet having a dopant that is different from the doped graphene sheets of the stack.

6. The nanocomposite of claim 1, further comprising:
a second doped graphene sheet with a second dopant coupled to the stack of doped graphene sheets; and
a third doped graphene sheet with a third dopant coupled to the second graphene sheet;
wherein said dopants individually enhance electrical and optical properties of a final nanocomposite.

7. The nanocomposite of claim 6, wherein said first, second and third graphene sheet are doped with a dopant selected from the group of dopants consisting of HNO₃, AuCl₃ and bis(trifluoromethane)sulfonimide (TFSA).

8. The nanocomposite of claim 6, wherein said polymer layer comprises a doped conductive polymer layer doped with a fourth dopant.

9. The nanocomposite of claim 8, wherein said fourth dopant comprises bis(trifluoromethane)sulfonimide (TFSA).

10. A method of fabricating a graphene-polymer nanocomposite material, the method comprising:
(a) fabricating a plurality of single layered graphene sheets;
(b) doping individual graphene sheets with at least one dopant species;
(c) stacking said individual doped graphene sheets into a stack of doped graphene sheets; and
(d) depositing a polymer layer over the stack of individually doped graphene sheets to form a graphene-polymer nanocomposite material;
(e) wherein the doping comprises layer-by-layer mixed chemical doping that incorporates different doping species to enhance electrical and optical properties individually.

11. The method of claim 10, wherein said individual graphene sheet is doped with a dopant species selected from the group of dopant species consisting of HNO₃, AuCl₃ and bis(trifluoromethane)sulfonimide (TFSA).

12. The method of claim 10, wherein said polymer layer comprises poly(3,4-ethylenedioxythiophene) polystyrene sulfonate, (PEDOT:PSS).

13. The method of claim 10, further comprising:
selecting a sequence of said graphene sheets doped with different dopants to form a sequenced stack of doped graphene sheets.

14. The method of claim 10, further comprising:
thermally treating the doped graphene sheets before depositing the polymer layer.

15. The method of claim 10, further comprising:
doping the graphene-polymer nanocomposite material to increase carrier density and reduce sheet resistance.

16. The method of claim 15, wherein said graphene-polymer nanocomposite material is doped with a bis(trifluoromethane)sulfonimide (TFSA) dopant.

17. The method of claim 10, further comprising:
coupling an undoped graphene sheet to a bottom surface of said stack.

18. A method of fabricating a graphene-polymer nanocomposite material, the method comprising:
(a) fabricating a plurality of single layered graphene sheets;
(b) doping individual graphene sheets with at least one of a first dopant species, a second dopant species or a third dopant species;
(c) selecting a sequence of said graphene sheets doped with different dopants;
(d) stacking said individual doped graphene sheets to form a sequenced stack of doped graphene sheets with a top and bottom surface; and
(e) depositing a polymer layer over the top surface of the sequenced stack of individually doped graphene sheets to form a graphene-polymer nanocomposite material;
(f) wherein the doping comprises layer-by-layer mixed chemical doping that incorporates different doping species to enhance electrical and optical properties individually.

19. The method of claim 18, further comprising:
doping the graphene-polymer nanocomposite material to increase carrier density and reduce sheet resistance.

20. The method of claim 18, further comprising:
coupling an undoped graphene sheet to said bottom surface of said sequenced stack of doped graphene sheets.

21. The method of claim 18, further comprising:
thermally treating the doped graphene sheets before depositing the polymer layer.

22. The method of claim 18, wherein said individual graphene sheets are doped with a dopant species selected from the group of dopant species consisting of HNO₃, AuCl₃ and bis(trifluoromethane)sulfonimide (TFSA).

23. The method of claim 18, wherein said first, second or third dopants comprise a mixture of two dopant species.
